(19) United States
(12) Patent Application Publication
(10) Pub. No.: US 2010/0124455 A1
(43) Pub. Date: May 20, 2010

(54) REVOLUTE JOINT WITH INTEGRATED RADIAL COMPLIANCE

(75) Inventors: Miroslaw Zaloga, Shelby Townhip, MI (US); George E. Doerr, Clarkston, MI (US); Christopher N. Bither, Commerce Township, MI (US); Christopher J. Mielke, Shelby Township, MI (US); Marco E. Rodriguez, Macomb Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/271,991

(22) Filed: Nov. 17, 2008

(51) Int. Cl. F16C 11/00; B62D 7/16

(52) U.S. Cl. 403/144; 403/120

(57) ABSTRACT

A pivot joint assembly includes a housing having a bore therethrough and a coaxial central axis. A stud is disposed coaxially with the bore, and has a bearing surface. A resilient member disposed between the housing and the stud is biased against the housing to accommodate radial loads transferred therebetween. An inner metal ring disposed between the resilient member and the bearing surface substantially surrounds the bearing surface and is sized for a sliding fit between the bearing surface and an interface surface of the inner metal ring. The stud is configured to pivot about the central axis by a range of at least 40 degrees. The pivot joint assembly may further include a sealing element configured to seal the bearing surface and the interface surface. Another embodiment includes an axial restraint element configured to prevent axial separation of the stud and housing.

### TECHNICAL FIELD

This disclosure relates to pivot joints for connecting linkages.

### BACKGROUND OF THE INVENTION

Steering systems utilize revolute joints to convert the rotational motion of the steering wheel (directly or indirectly communicated to the revolute joint) into the linear motion needed to turn the wheels. In the case of recirculating ball steering systems, rotation of a pitman arm is converted into generally linear movement of a track rod or relay bar, which is coupled to the wheels to turn the vehicle.

Revolute joints transfer loads from one relatively rigid component to another relatively rigid component while allowing relative rotation or revolution between the two components. Relative to the central axis of the revolute joint, there are four possible types of movement: revolution, radial displacement, axial displacement, and angulation.

### SUMMARY

A pivot joint assembly is provided, including a housing having a bore therethrough and a central axis coaxial with the bore. A stud is disposed coaxially with the central axis of the bore, and has a bearing surface. A resilient member is disposed between the housing and the stud, and is biased against the housing to accommodate radial loads transferred between the stud and the housing. An inner metal ring is disposed between the resilient member and the bearing surface. The inner metal ring substantially surrounds the bearing surface and is sized for a sliding fit between the bearing surface and an interface surface of the inner metal ring. The stud is configured to pivot about the central axis by a range of at least 40 degrees relative to the housing.

One embodiment of the pivot joint assembly further includes one or more sealing elements configured to seal the bearing surface and the interface surface against the passage of foreign material or lubricant. Another embodiment of the pivot joint assembly further includes an axial restraint element configured to prevent axial separation of the stud from the housing.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic, isometric view of a recirculating ball steering mechanism having a pivot joint assembly;

FIG. 2 is a schematic, partial cross-sectional view of the pivot joint assembly shown in FIG. 1;

FIG. 3 is a schematic, cross-sectional view of a second embodiment of a pivot joint assembly having an angled, two-piece resilient member;

FIG. 4 is a schematic, cross-sectional view of a third embodiment of a pivot joint assembly having an annular ridge axial restraint and an axial cap;

FIG. 5 is a schematic, partial cross-sectional view of a fourth embodiment of a pivot joint assembly having a two-piece inner metal ring and a lubricant nozzle; and

FIG. 6 is a schematic, partial cross-sectional view of a fifth embodiment of a pivot joint assembly having a sealing element formed as an integral part of the resilient member.

### DESCRIPTION OF PREFERRED EMBODIMENTS

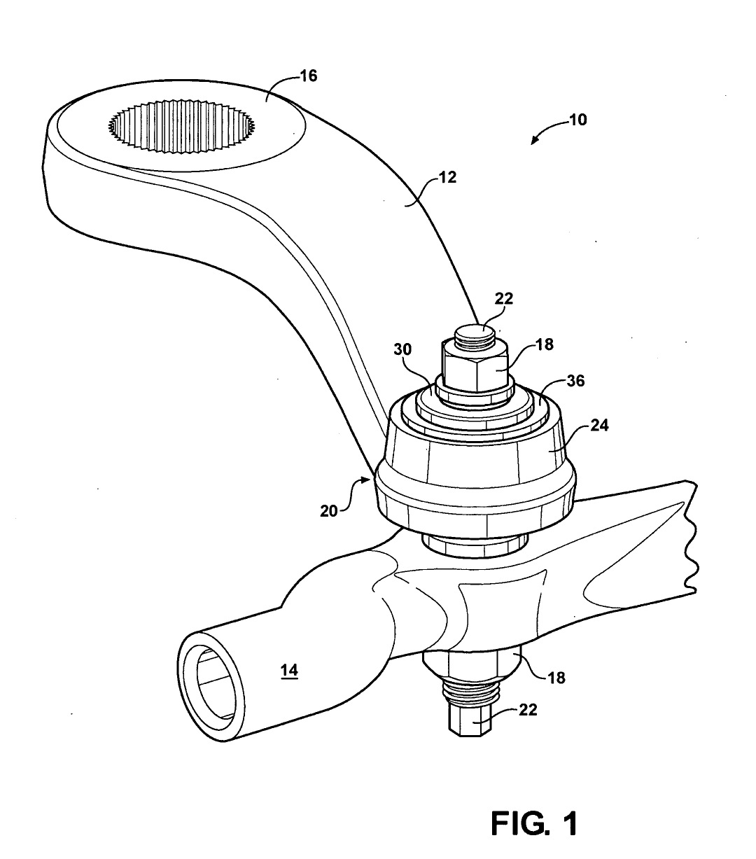

Referring to the drawings, wherein like reference numbers correspond to like or similar components throughout the several figures, there is shown in FIG. 1 steering mechanism 10, which may be included in a recirculating ball steering system. The steering mechanism 10 includes a pitman arm 12 and a relay rod 14. As pitman arm 12 is rotated by a sector gear (not shown) mated to a splined portion 16, rotation of the pitman arm 12 is transferred as lateral motion to the relay rod 14.

While the present invention is described in detail with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims.

Motion is transferred between the pitman arm 12 and relay rod 14 through a pivot joint assembly 20. A pin or stud 22 extends between the relay rod 14 and the pitman arm 12. In the embodiment shown, upper and lower nuts 18 hold the components together. Opposite the splined portion 16 of the pitman arm 12 is a housing 24 which surrounds or substantially surrounds a portion of the stud 22 (the upper portion, as viewed in the figures).

As described herein, the pivot joint assembly 20—and other embodiments of pivot joint assemblies described below—is capable of translating the rotation of the pitman arm 12 into substantially lateral motion of the relay rod 14. The pivot joint assembly 20 allows rotation of the stud 22 relative to the pitman arm 12 and the housing 24. Vibrations and road excitations may be transferred from the vehicle's wheels into the relay rod 14, causing relay rod 14 to twist or push against the pivot joint assembly 20. The pivot joint assembly 20 is configured to accommodate some or all of the torque and force created by such relative movement between the relay bar 14 and the pitman arm 12.

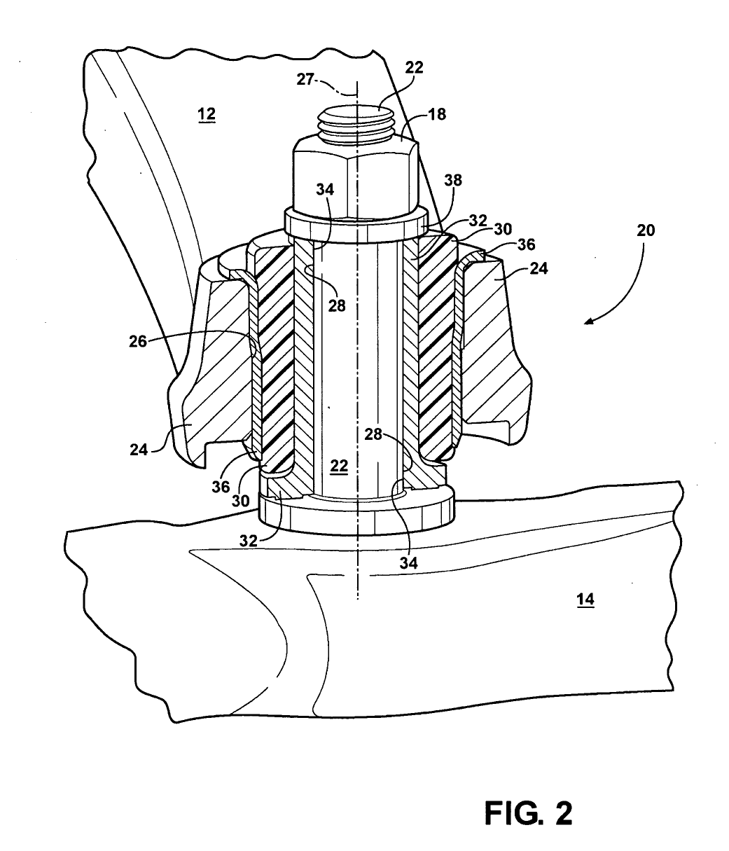

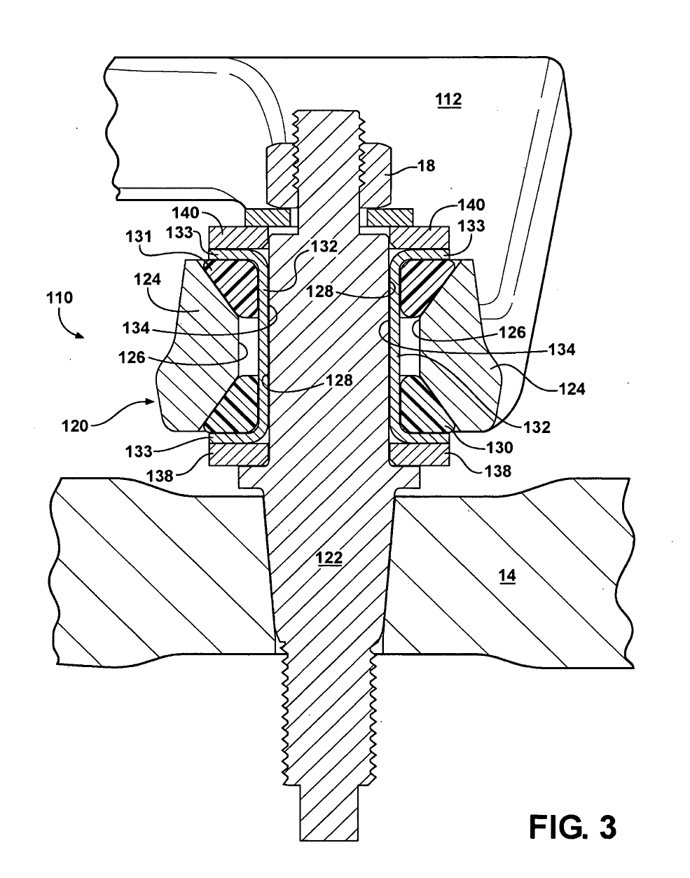

Referring now to FIG. 2—and with continued reference to FIG. 1—there is shown in FIG. 2 a close up view of the steering mechanism 10 shown in FIG. 1, showing a partial cross section of the pivot joint assembly 20. The housing 24 has a generally cylindrical bore 26 running therethrough and a central axis 27 coaxial with the bore 26. As shown and described below in relation to FIG. 3 (and also in relation to the other embodiments), the bore 26 need not be continuous and may have multiple, offset, or angled portions.

Stud 22 has a bearing surface 28 disposed substantially within bore 26 and oriented to be substantially coaxial with the central axis 27. In the embodiment shown in FIG. 2, the bearing surface 28 is substantially cylindrical. The pivot joint assembly 20 further includes a resilient member or bushing 30 disposed between the bore 26 and the bearing surface 28. Bushing 30 may be a rubber bushing or formed of other material known to those having ordinary skill in the art as being compatible with greases which may be used in the pivot joint assembly 20.

In operation of steering system 10, the bushing 30 is biased against the housing 24 to accommodate radial loads between the stud 22 and the housing 24. As used herein, radial refers to displacement or loads generally perpendicular to the central axis 27. Radial displacement or loads may also be referred to as lateral movement or loads.

Additional degrees of freedom of relative movement between the stud 22 and the housing 24 are: axial, which occurs along the central axis 27 (up and down, as viewed in FIG. 2); rotation, revolution or pivoting about the central axis 27; and angulation, which occurs as the stud 22 and central axis 27 rock or wobble. Angulation is demonstrated by, for example, the top of stud 22 moving to the right (as shown in FIG. 2) while the bottom of stud 22 stays fixed or moves to the left.

An inner metal ring 32 may be disposed between the bushing 30 and bearing surface 28. The inner metal ring 32 substantially surrounds the bearing surface 28, and is sized for a sliding fit between an interface surface 34 of the inner metal ring 32 and the bearing surface 28. The interface surface 34 and bearing surface 28 act similar to a journal bearing to allow rotation of the stud 22 about the central axis 27 relative to the housing 24.

To limit the intrusion of dust, dirt, water, or other foreign material into the gap between the interface surface 34 and the bearing surface 28, the pivot joint assembly 20 may be equipped with a sealing structure. The pivot joint assembly 20 shown in FIGS. 1 and 2 includes a thrust bearing 38, which may also be configured to prevent the ingress of foreign material into, and the egress of lubricant from, the interface surface 34 and bearing surface 28.

As shown in FIG. 2, the pivot joint assembly 20 includes an outer can 36 disposed substantially between the bushing 30 and the bore 26. The outer can 36 may compress the bushing 30 against the inner metal ring 32, and may assist in assembly of the pivot joint assembly 20.

The stud 22 is configured to pivot about the central axis 27 by a range of at least 40 degrees relative to the housing 24. For example, without limitation, if the pitman arm 12 has a zero or starting location in the steering mechanism 10—such as the position corresponding to the non-turning center location of the steering wheel—the pitman arm 12 may rotate away from that center position through a range of at least 20 degrees in either direction of rotation (a total range of 40 degrees) about the central axis 27.

Some embodiments of the pivot joint assembly 20 may be further configured for rotation through a broader range of at least 80 degrees. Although unlikely to occur in embodiments of the pivot joint assembly 20 used within steering systems, the pivot joint assembly 20 may be configured to allow for complete rotation through a range of 360 degrees.

In addition to the rotational compliance provided by the interface surface 34 and the bearing surface 28, the pivot joint assembly 20 is further configured to provide radial compliance between the stud 22 and housing 24. Radial compliance is the ability of the pivot joint assembly 20 to accommodate relative radial displacement between the stud 22 (which is transferred from the relay rod 14) and the housing 34. This may occur when the relay rod 14 moves quickly in the direction opposite the turning motion of the pitman arm 12.

Bushing 30 is configured to provide radial compliance in a range of approximately 750-2500 newtons per millimeter (N/mm) of radial displacement between the stud 22 and the housing 24. Some embodiments of the pivot joint assembly 20 may be configured to provide radial compliance in a range of approximately 1200-2000 (N/mm). Additionally, the bushing 30 is configured to provide angulate compliance between the stud 22 and housing 24.

Radial (lateral) compliance may be beneficial for tuning the feel, handling, and response characteristics of the steering mechanism 10. Changes in radial compliance alter the way the steering mechanism 10 (and associated elements of the vehicle's steering system) responds to lateral loads. Handling characteristics are affected by radial compliance as a result of increases or decreases in the amount of lateral loading transferred through relay rod 14 to the pitman arm 12, and compliance therefore also alters the amount of steering response transferred from steerable wheels to the driver (usually felt at the steering wheel).

Referring now to FIG. 3, there is shown a cross-sectional view of another embodiment of a steering mechanism 110. A pitman arm 112 translates motion to the relay bar 14 through a pivot joint assembly 120. The pitman arm 112 and a stud 122 are generally similar to those shown in FIG. 2. However, a housing 124 which substantially surrounds the stud 122 has a differently-shaped bore 126 running therethrough. Unlike the bore 26 shown in FIG. 2, the bore 126 is not generally cylindrical, but has angled portions.

A substantially-cylindrical bearing surface 128 rotates within an interface surface 134 of an inner metal ring 132, such that the stud 122 may rotate about a central axis (not shown) relative to the housing 124. Inner metal ring 132 includes radial tab portions 133 which are generally perpendicular to the interface surface 134 (and central axis of stud 122). Radial tab portions 133 may be continuous rings, or may have multiple, individual tabs or stakes. Pivot joint assembly 20 does not include an outer metal can (such as outer metal can 36 shown in FIG. 2).

The radial tab portions 133 restrict axial movement of the stud 122 relative to the housing 124. The pivot joint assembly 120 includes a two-piece resilient member formed from a first bushing 130 and a second bushing 131. The first and second bushings 130 and 131 shown in FIG. 3 are disposed between the angular portions of the bore 126 and the inner metal ring 132 (including radial tab portions 133).

First and second bushings 130 and 131 are further configured to provide radial compliance between the stud 122 and housing 124. Additionally, the first and second bushings 130 and 131 may be configured with differing compliance levels, which allows tuning of both the radial and angulate reactions of the pivot joint assembly 120.

The radial tab portions 133 act as axial restraint elements configured to prevent axial separation of the stud 122 from the housing 124. In the unlikely event of a loss of the either the first bushing 130 or second bushing 131, the radial tab portions 133 would not allow the inner metal ring 132, and therefore the stud 122, to be completely detached or separated from the housing 124.

To limit the intrusion of dust, dirt, water, or other foreign material into the gap between the interface surface 134 and the bearing surface 128, the pivot joint assembly 120 may also be equipped with sealing structures. The pivot joint assembly 120 includes two such structures, a first thrust bearing 138 and a second thrust bearing 140, which, in addition to carrying axial loads, may be configured to prevent the ingress of foreign material into, and the egress of lubricant from, the interface surface 134 and bearing surface 128. The thrust bearings 138 and 140 may be formed from, or have a coating made from (without limitation): microcellular polyurethane (MCU), polyurethane foam, or rubber.

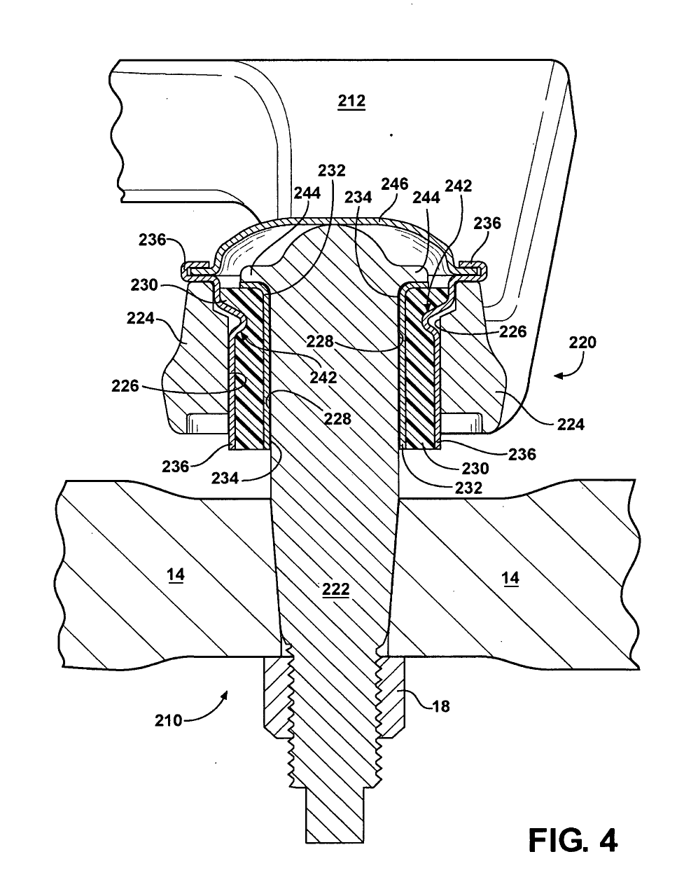

Referring now to FIG. 4, there is shown a cross-sectional view of another embodiment of a steering mechanism 210. A pitman arm 212 translates motion to the relay bar 14 through a pivot joint assembly 220. The pitman arm 212 is generally similar to those shown in FIGS. 2 and 3. However, a housing 224 which substantially surrounds the stud 222 again has a differently-shaped bore 226 running therethrough. Unlike the bore 26 shown in FIG. 2, the bore 226 is not generally cylindrical, but includes both offset and angled portions.

A substantially-cylindrical bearing surface 228 rotates within an interface surface 234 of an inner metal ring 232, such that the stud 222 may rotate about a central axis (not shown) relative to the housing 224. The pivot joint assembly 220 includes a single-piece resilient member, a bushing 230. The bushing 230 is disposed between the inner metal ring 232 and an outer metal can 236, and configured to provide radial compliance between the stud 222 and housing 224.

An annular ridge 242 on the outer metal can 236 acts as an axial restraint element configured to prevent axial separation of the stud 222 from the housing 224. The stud 222 includes a radial ridge 244 on an upper portion thereof. In the unlikely event of a loss of the bushing 230, the annular ridge 242 would not allow the radial ridge 244 of the stud 222, and therefore the stud 222, to be completely detached from the housing 224.

In another embodiment (not shown) of the pivot joint assembly 220, the annular ridge 242 may be formed directly into the housing 224. In such an embodiment, the pivot joint assembly 220 may not include the outer metal can 236 and the bushing 230 would be displaced between the housing 224 and inner metal ring 232.

Pivot joint assembly 220 shown in FIG. 4 does not include separate sealing structures like the first and second thrust bearings 138 and 140. However an axial cap 246 is configured to prevent the ingress of foreign material into, and the egress of lubricant from, the interface surface 234 and bearing surface 228. Axial cap 246 is attached to the outer metal can 236, and therefore also restricts axial movement of the stud 222 relative to the housing 224. Axial cap 246 may also allow the steering mechanism 210 to be assembled without one of the nuts 18 (shown in FIGS. 1-3).

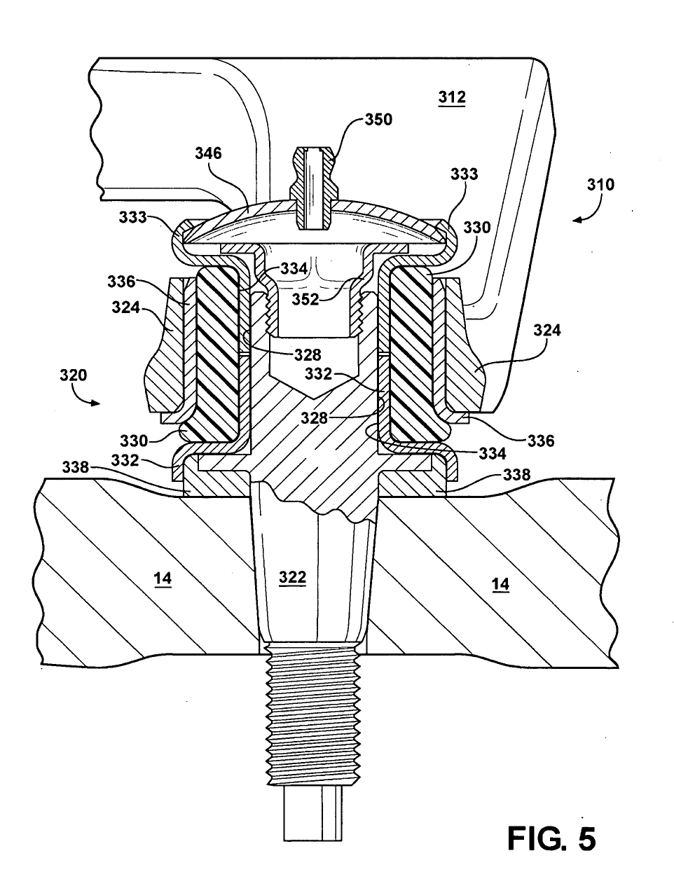

Referring now to FIG. 5, there is shown a cross-sectional view of another embodiment of a steering mechanism 310. A pitman arm 312 translates motion to the relay bar 14 through a pivot joint assembly 320.

The pivot joint assembly 320 includes a two-piece inner metal ring member, such that a substantially-cylindrical bearing surface 328 on a stud 322 rotates within an interface surface 334, which is formed on a first inner metal ring 332 and a second inner metal ring 333. Note that the stud 322 is shown as a partial cross section.

The pivot joint assembly 320 includes a single-piece resilient member, a bushing 330. The bushing 330 is disposed between the first and second inner metal rings 332 and 333, and an outer metal can 336, and configured to provide radial compliance between the stud 322 and housing 324.

Like the pivot joint assembly 220 shown in FIG. 3, the interior of pivot joint assembly 320 is completely sealed. A first sealing element 338 and an axial cap 346 are configured to prevent the ingress of foreign material into, and the egress of lubricant from, the interface surface 334 and bearing surface 328. First sealing element 338 may be formed from, or have a coating made from, without limitation: microcellular polyurethane (MCU), polyurethane foam, or rubber.

In the pivot joint assembly 320, the axial cap 346 is attached to the second inner metal ring 333, as opposed to the outer metal can 336. Axial cap 346 may be attached to the second inner metal ring 333 by rolling or otherwise deforming a lip on the second inner metal ring 333 over the edge of axial cap 346. An internal nut 352 locks the stud 322 against the second inner metal ring 333 and carries axial loads.

A nozzle or zerk fitting 350 is disposed in axial cap 346. Zerk fitting 350 is a nipple-like lubrication fitting through which grease is applied to the interior of pivot joint assembly 220, and may be made of zirconium alloy (which may be referred to as a zirc fitting).

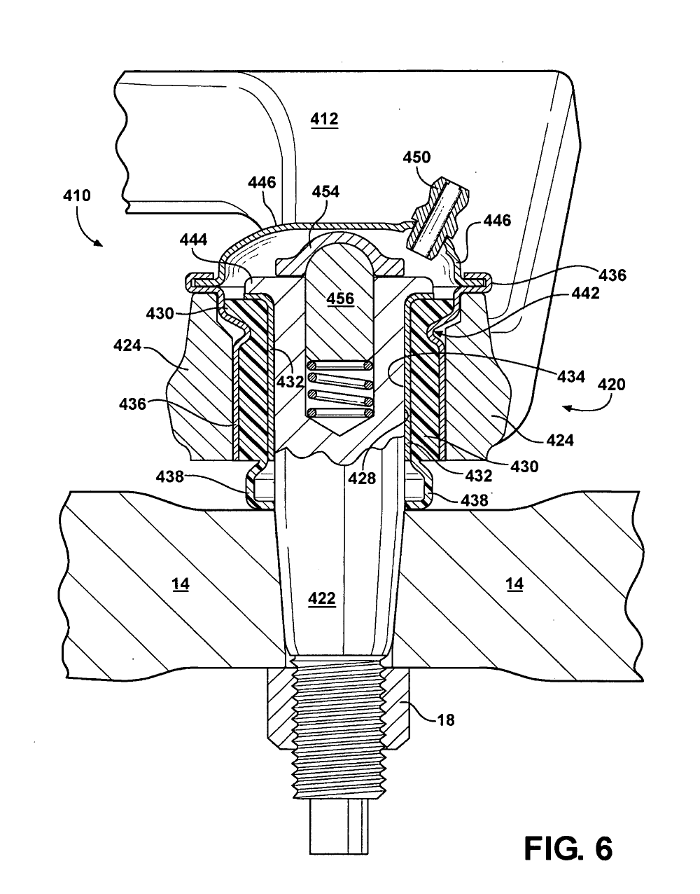

Referring now to FIG. 6, there is shown a cross-sectional view of another embodiment of a steering mechanism 410. A pitman arm 412 translates motion to the relay bar 14 through a pivot joint assembly 420.

A substantially-cylindrical bearing surface 428 on a stud 422 rotates within an interface surface 434 of an inner metal ring 432, such that the stud 422 may rotate about a central axis (not shown) relative to the housing 424. Note that the stud 422 is shown as a partial cross section. The pivot joint assembly 420 includes a single-piece resilient member, a bushing 430. The bushing 430 is disposed between the inner metal ring 432 and an outer metal can 436, and configured to provide radial compliance between the stud 422 and housing 424.

An annular ridge 442 on the outer metal can 436 acts as an axial restraint element configured to prevent axial separation of the stud 422 from the housing 424. The stud 422 includes a radial ridge 444 on an upper portion thereof. In the unlikely event of a loss of the bushing 430, the annular ridge 442 would not allow the radial ridge 444 of the stud 422, and therefore the stud 422, to be completely detached or separated from the housing 424.

The interior of pivot joint assembly 420 is also sealed. An axial cap 446 is configured to prevent the ingress of foreign material into, and the egress of lubricant from, the interface surface 434 and bearing surface 428. Furthermore, a sealing portion 438 is formed as a continuous, integral portion of the bushing 430, thereby eliminating the need for an additional sealing element on the lower portion of the pivot joint assembly 420.

Axial cap 446 is attached to the outer metal can 436, and therefore restricts axial movement of the stud 422 relative to the housing 424. A thrust bearing 454 carries axial loads to the axial cap 446, and a pin 456 carries loads from a spring or another elastic member to the thrust bearing 454. A zerk fitting 450 is disposed in axial cap 446, allowing grease to be applied into the interior of pivot joint assembly 420.

While the best modes and other embodiments for carrying out the claimed invention have been described in detail, those familiar with the art to which this invention relates will recognize various alternative designs and embodiments for practicing the invention within the scope of the appended claims.

1. A pivot joint assembly comprising:
a housing having a bore therethrough and a central axis coaxial with said bore;
a stud having a bearing surface disposed within said bore and coaxial with said central axis;
a resilient member disposed between said housing and said stud, wherein said resilient member is biased against said housing to accommodate radial loads between said stud and said housing;
an inner metal ring disposed between said resilient member and said bearing surface, wherein said inner metal ring substantially surrounds said bearing surface and is sized to provide a sliding fit between said bearing surface and an interface surface of said inner metal ring; and
wherein said stud is configured to pivot about said central axis by a range of at least 40 degrees relative to said housing.

2. The pivot joint assembly of claim 1, further comprising a first sealing element configured to seal said bearing surface and said interface surface against the passage of foreign material or lubricant.

3. The pivot joint assembly of claim 2, further comprising a second sealing element configured to seal said bearing surface and said interface surface against the passage of foreign material or lubricant.

4. The pivot joint assembly of claim 3, wherein said first sealing element is formed as a continuous portion of said resilient member.

5. The pivot joint assembly of claim 1, further comprising an axial restraint element configured to prevent axial separation of said stud from said housing.

6. The pivot joint assembly of claim 5, further comprising an outer can disposed substantially between said resilient member and said bore.

7. The pivot joint assembly of claim 6, wherein said axial restraint element includes an annular ridge formed on one of said housing and said outer can.

8. The pivot joint assembly of claim 7, further comprising an axial cap operatively attached to said outer can, wherein said axial cap is configured to prevent axial displacement of said stud.

9. The pivot joint assembly of claim 1, wherein said stud is configured to pivot about said central axis by a range of at least 80 degrees relative to said housing.

10. The pivot joint assembly of claim 9, wherein said bearing surface is substantially cylindrical.

11. The pivot joint assembly of claim 1, wherein said resilient member is configured to provide a radial compliance of between approximately 750 to 2500 newtons per millimeter of radial displacement.

12. The pivot joint assembly of claim 1, wherein said resilient member is an elongated elastomeric bushing.

13. The pivot joint assembly of claim 1, wherein said resilient member is a two-piece elastomeric bushing.

14. The pivot joint assembly of claim 13, wherein said inner metal ring is a two-piece inner metal ring.

15. A pivot joint assembly comprising:
a housing having a bore therethrough and a central axis coaxial with said bore;
a stud having a bearing surface disposed within said bore and coaxial with said central axis;
a resilient member disposed between said housing and said stud, wherein said resilient member is biased against said housing to accommodate radial loads between said stud and said housing;
an inner metal ring disposed between said resilient member and said bearing surface, wherein said inner metal ring substantially surrounds said bearing surface and is sized to provide a sliding fit between said bearing surface and an interface surface of said inner metal ring;
a sealing element configured to seal said bearing surface and said interface surface against the passage of foreign material or lubricant; and
wherein said stud is configured to pivot about said central axis by a range of at least 40 degrees relative to said housing.

16. The pivot joint assembly of claim 15, wherein said sealing element is formed as a continuous portion of said resilient member.

17. The pivot joint assembly of claim 16, further comprising an axial restraint element configured to prevent axial separation of said stud from said housing.

18. The pivot joint assembly of claim 17, further comprising an outer can disposed substantially between said resilient member and said bore, wherein said axial restraint element includes an annular ridge on one of said housing and said outer can.

19. The pivot joint assembly of claim 18, wherein said stud is configured to pivot about said central axis by a range of at least 80 degrees relative to said housing.
